(19) United States
(12) Patent Application Publication
(10) Pub. No.: US 2005/0247790 A1
(43) Pub. Date: Nov. 10, 2005

(54) Reading apparatus for bar code on a test tube

(75) Inventor: Teruaki Itoh, Kumamoto-shi (JP)

Correspondence Address: NIXON & VANDERHYE, PC, 901 NORTH GLEBE ROAD, 11TH FLOOR, ARLINGTON, VA, 22203, US

(73) Assignee: IDS Co., Ltd., Kumamoto-shi (JP)

(21) Appl. No.: 11/111,769

(22) Filed: Apr. 22, 2005

(30) Foreign Application Priority Data
Apr. 26, 2004 (JP) 2004-129780

(51) Int. Cl. G06K 7/10

(52) U.S. Cl. 235/462.01; 235/470

(57) ABSTRACT

A bar code reading apparatus has a reader and a test tube handling mechanism. The reader is provided on the side of a bar code reading position set above on the way of a conveying path, and reads a bar code of a test tube. The test tube handling mechanism is placed above the bar code reading position. The test tube handling mechanism descends to grab a test tube held by a test tube holder stopped at a test tube lifting position set right below the bar code reading position, and ascends to draw out the grabbed test tube from the test tube holder. The test tube handling mechanism faces a bar code of a test tube by rotating a lifted test tube.

### CROSS-REFERENCE TO RELATED APPLICATIONS

This application is based upon and claims the benefit of priority from the prior Japanese Patent Application No. 2004-129780, filed Apr. 26, 2004, the entire contents of which are incorporated herein by reference.

### BACKGROUND OF THE INVENTION

1. Field of the Invention

The present invention relates to an apparatus for reading a bar code affixed to a test tube, which is provided on the way of a conveying path for automatically conveying test tubes.

2. Description of the Related Art

A test tube containing a sample such as blood is labeled a bar code including information about the sample, such as components of the sample, liquid level of principal component, and volume of the contents. The bar code is detected with a reading apparatus provided on the way of a conveying path for automatically conveying the test tube. The information read with the reading apparatus is sent to a unit provided on the downstream side.

A conventional bar code reading apparatus is shown in FIG. 4 and FIG. 5. The reading apparatus has a reader 9 and a holder rotating mechanism 10. The reader 9 is fixed on the side of a bar code reading position provided on the way of a conveying path 5 for conveying a test tube 1. The test tube moved along the conveying path 5 is held vertically by a test tube holder 3. The test tube 1 has a bar code affixed to its upper periphery.

The reader 9 reads a bar code 2 of the test tube 1 at the bar code reading position. The holder rotating mechanism 10 is placed opposite to the reader 9 through the conveying path 5. The holder rotating mechanism 10 has a pair of friction rollers 11 and 12, an endless belt 13, and a driving motor 14.

The friction rollers 11 and 12 are held by a guide rail 7 on one side of the conveying path 5, and rotated freely around the vertical axis. The friction rollers 11 and 12 are pressed to the periphery of a cylindrical part 4 of the test tube holder 3 located at the bar code reading position. The endless belt 13 is wound around pulleys provided coaxially with the friction rollers 11 and 12.

The driving motor 14 is connected to the friction roller 11 to rotate it. The friction roller 12 is rotated together with the friction roller 11 by the endless belt 13 in the direction of the arrow in FIG. 5. The holder rotating mechanism 10 rotates the test tube 1 together with the test tube holder 3 by the friction rollers 11 and 12, and makes the bar code 2 face the reader 9.

The test tube holder 3 has a pair of flanges 4a and 4b in the lower periphery of the cylindrical part 4, and a circular groove 4c formed between the flanges 4a and 4b. The cylindrical part 4 has a leaf spring to hold vertically the test tube 1 inserted inside. The conveying path 5 has a belt conveyor 6 and guide rails 7 and 8. The belt conveyor 6 carries the test tube holder 3 vertically at a certain interval, and conveys it intermittently. The guide rails 7 and 8 are provided on both sides of the belt conveyor 6, and have guide projection beams 7a and 8a which fit in the circular groove 4c with a clearance.

A gap is formed in the joint between the circular groove 4c and guide projection beams 7a and 8a. Thus, when the friction rollers 11 and 12 rotate pressing the cylindrical part 4 from one side, the test tube holder 3 is inclined as indicated by the broken line in FIG. 4. As a result, the test tube 1 is also inclined, causing a failure of reading the bar code 2. Further, as the flanges 4a and 4b are pressed to the guide rails 7 and 8, the test tube holder 3 is not rotated. Thus, the bar code 2 cannot be made to face to the reader 9.

### BRIEF SUMMARY OF THE INVENTION

In the bar code reading apparatus according to the present invention, a test tube is rotated while being held. Thus, a bar code can be correctly read without inclining a test tube.

The bar code reading apparatus reads a bar code indicated on the outside of a test tube conveyed while being held by a test tube holder on a conveying path of an apparatus such as an automatic analyzer. The test tube holder holds a test tube having a bar code on the outside. The conveying path conveys the test tube holder with the test tube standing up straight.

The bar code reading apparatus is composed of a reader and a test tube handling mechanism. The reader is provided on the side of the bar code reading position set above the conveying path, and reads a bar code affixed to a test tube. The test tube handling mechanism is arranged above the bar code reading position. The test tube handling mechanism descends to hold a test tube held by the test tube holder stopped at the test tube lifting position set right below the bar code reading position, and ascends to pulled out the test tube from the test tube holder. The test tube handling mechanism faces a bar code of a test tube to the reader by rotating the lifted test tube.

In this case, the test tube handling mechanism comprises a clamp unit, a lifting unit, a rotation-driving unit, and a lifting cylinder. The clamp unit comprises a pair of clamps to nip the upper part of the test tube, and an open/close cylinder to drive the clamp. The lifting unit holds the clamp unit rotatably. The rotation-driving unit is provided in the lifting unit, and rotates the clamp unit. The lifting cylinder has a stroke to move the lifting unit from a lower limit position where the clamp grabs the test tube, to an upper limit position where the test tube is drew out from the test tube holder to rotate the test tube.

To read a bar code quickly, two readers are prepared and placed at a height capable of reading a bar code of a test tube held at the upper limit position of the lifting unit, and at the position symmetric with respect to the test tube. The rotation-driving unit rotates the clamp unit reversibly in a range of 180 degrees.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a perspective view of a reading apparatus for a bar code on a test tube according to an embodiment of the present invention;

FIG. 2 is a side view of the bar code reading apparatus shown in FIG. 1, with an lifting unit located at an upper limit position and a clamp opened;

FIG. 3 is a side view of the bar code reading apparatus shown in FIG. 1, with a test tube lifted to a bar code reading position;

FIG. 4 is a side view of a conventional apparatus for reading a bar code on a test tube; and

FIG. 5 is a plane view showing the height position of the friction rollers shown in FIG. 4.

1 . . . Test tube, 2 . . . Bar code, 3 . . . Test tube holder, 5 . . . Test tube conveying path, 9a, 9b . . . Reader, 20 . . . Lifting test tube handling mechanism, 21, 22 . . . Pair of open/close clamps, 23 . . . Open/close cylinder, 25 . . . Clamp unit, 26 . . . Lifting body, 27 . . . Rotation-driving means, 27a . . . Rotary actuator, 28 . . . Lifting cylinder

### DETAILED DESCRIPTION OF THE INVENTION

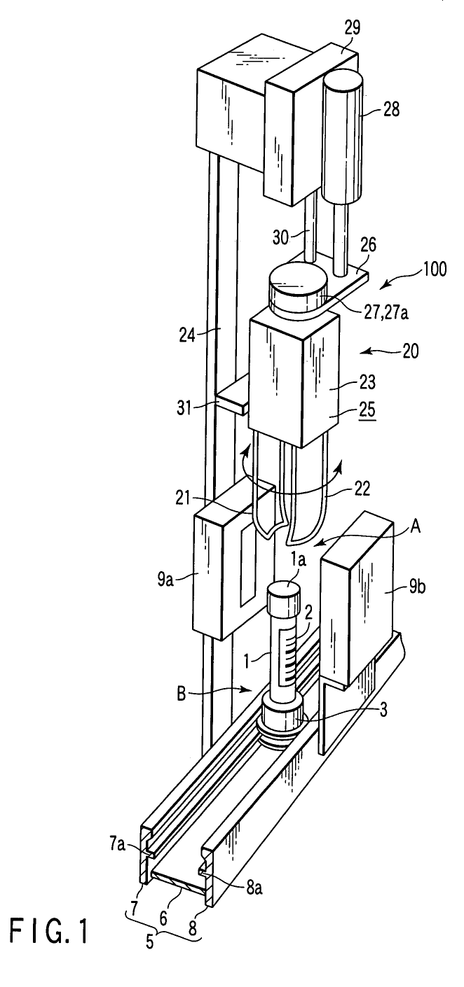

A bar code reading apparatus 100 according to an embodiment of the present invention will be explained with reference to FIG. 1 to FIG. 3. The bar code reading apparatus 100 is an apparatus to read a bar code 2 affixed to a test tube 1. The test tube 1 contains a sample such as blood, and the upper end port is closed with a plug 1a. The test tube 1 is conveyed on a conveying path 5 in the state of standing vertically in a test tube holder 3. The conveying path 5 is provided in a part of a unit which automatically analyzes the contents of the test tube 1.

The test tube holder 3 has a cylindrical part 4 to insert the test tube 1. The cylindrical part 4 has a pair of flanges 4a and 4b in two steps on the lower periphery. A circular groove 4c is formed between the flanges 4a and 4b. The cylindrical part 4 has a leaf spring inside to hold vertically the inserted test tube 1. The conveying path 5 is composed of a belt conveyor 6 and guide rails 7 and 8.

The belt conveyor 6 carries the test tube holder 3 at a certain interval with the test tube 1 held vertically, and conveys the test tube holder intermittently. The guide rails 7 and 8 are placed on both sides along the conveying direction. The guide rails 7 and 8 have guide projection beams 7a and 8a projecting toward the belt conveyor 6. The guide projection beams 7a and 8a are fitted in the circular groove 4c with a clearance.

The bar code reading apparatus 100 comprises two readers 9a and 9b, and a test tube handling mechanism 20. The readers 9a and 9b are provided on both sides of a bar code reading position A set above the way of conveying path 5, to read the bar code 2 on the test tube 1. The test tube handling mechanism 20 is placed further above the bar code reading position A. A test tube lifting position B is set above the belt conveyor 6 right under the bar code reading position A. The test tube handling mechanism 20 handles the test tube 1 inserted into the test tube holder 3 stopped at the test tube lifting position B.

The test tube handling mechanism 20 comprises a clamp unit 25, a lifting unit 26, a rotation-driving unit 27, and a lifting cylinder 28. The clamp unit 25 comprises clamps 21 and 22 to nip the upper part of the test tube 1, and an open/close cylinder 28 to drive the clamps 21 and 22.

The lifting unit 26 holds the clamp unit 25 rotatably. The rotation-driving unit 27 is provided in the lifting unit 26, and rotates the clamp unit 25. The lifting cylinder 28 has a stroke S to move the lifting unit 26 from a lower position where the clamps 21 and 22 grab the test tube 1, to an upper position where the test tube 1 is pulled out from the test tube holder up to a height sufficient to rotate the test tube 1.

A base body to which the conveying path 5 is fixed has a support frame 24 extending upward and vertically from the conveying path. The lifting cylinder 28 is fixed to a support body 29 provided in the upper end of the support frame 24. The support frame 24 has a frame bracket 31 halfway. A guide rod 30 is provided between the support body 29 and frame bracket 31. The lifting unit 26 is passed through the guide rod 30 and moved vertically by the lifting cylinder 28.

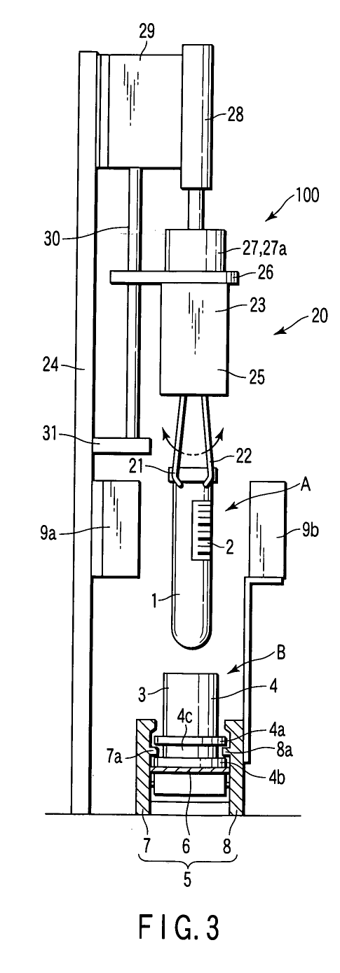

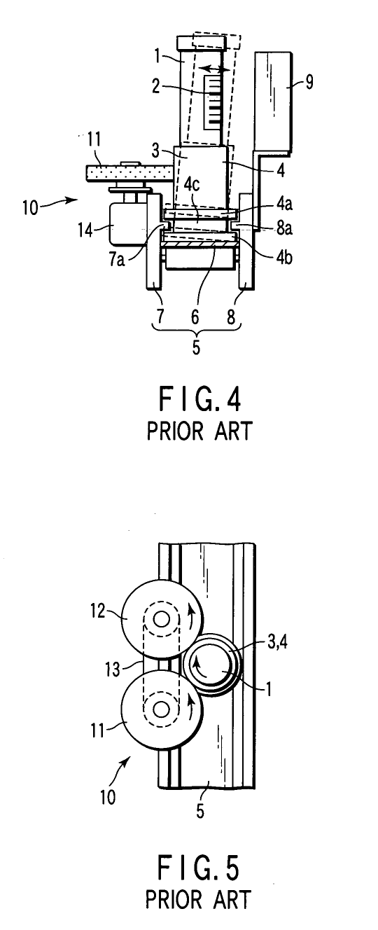

The readers 9a and 9b are placed symmetrically at a position sandwiching the test tube 1 at a height capable of reading the bar code 2 of the test tube 1 suspended by the test tube handling mechanism 20 raised to the upper limit position as shown in FIG. 3.

The test tube handling mechanism 20 descends to grab the test tube 1 held by the test tube holder 3 stopped at the test tube lifting position, and ascends to draw out the held test tube 1 from the test tube holder 3. The test tube handling mechanism 20 makes the bar code 2 of the test tube 1 face the readers 9a and 9b by rotating the lifted test tube 1.

When one reader is provided, the clamp unit 25 grabbing the test tube 1 is rotated one turn by the rotation-driving unit 27 such as a motor. As shown in FIG. 1 to FIG. 3, when two readers 9a and 9b are provided, the clamp unit 25 grabbing the test tube 1 is rotated 180° by a rotary actuator 27a used as a rotation-driving unit 27 for rotating reversibly through an angle range of 180°. Thus, the bar code 2 of the test tube 1 is certainly detected by the readers 9a and 9b.

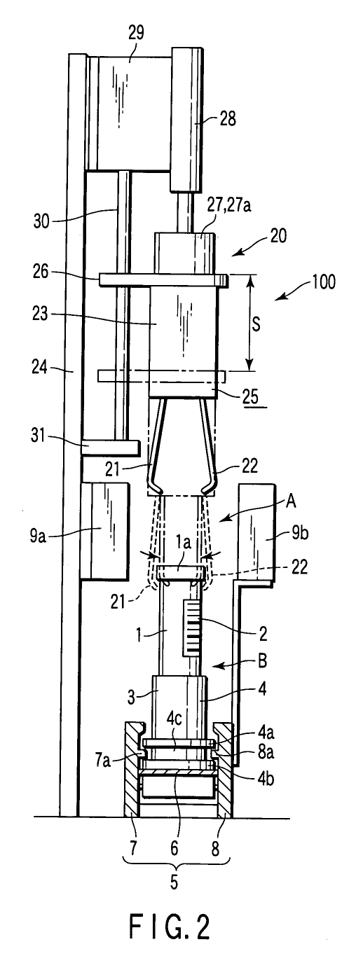

FIG. 1 and FIG. 2 show the test tube handling mechanism 20 at the upper limit position with the clamps 21 and 22 opened. When the test tube holder 3 containing the test tube 1 is stopped at the bar code reading position A, the clamp unit 25 is lowered by the lifting cylinder 28 to the lower limit position capable of grabbing a test tube indicated by the long dashed double-short dashed line in FIG. 2. The open/close cylinder 23 closes the clamps 21 and 22 from the opened state indicated by a broken line in FIG. 2, to the clamped state indicated by the long dashed double-short dashed line. As a result, the upper end portion of the test tube 1 is chucked by the clamps 21 and 22.

The test tube handling mechanism 20 elevates the clamp unit 25 while clamping the test tube 1, by operating the lifting cylinder 28. After the test tube 1 is drew out from the test tube holder 3, the clamp unit 25 stops at the upper limit position and holds the test tube 1 at a position of rotating it, as shown in FIG. 3.

While holding the clamp unit 25 at the upper limit position, the test tube handling mechanism 20 operates the rotary actuator 27a and rotates reversibly the test tube 1 held by the clamps 21 and 22 through a range of 180 degrees. Thus, the bar code 2 of the test 1 is passed in front of one of the readers 9a and 9b, and certainly read.

After the bar code 2 is read, the test tube handling mechanism 20 lowers the clamp unit 25. The test tube 1 is returned to the test tube holder 3. The clamps 21 and 22 move to the opened state indicated by the broken line in FIG. 2, and release the test tube 1. The test tube handling mechanism 20 returns to above the test tube lifting position B, and stands by. This completes a series of bar code reading operation.

After the bar code is read, the test tube 1 is conveyed by the belt conveyor 6 to a processing unit in the next process provided in the downstream of the conveying path 5. A new test tube 1 brought into the test tube lifting position B. The above described series of bar code reading operations will be performed.

The bar code reading apparatus according to the present invention picks up a test tube by the test tube handling mechanism, rotates the test tube in front of the reader, and reads the bar code of the test tube. The rotation of the test tube around the vertical axis is stable while the bar code is read. Therefore, the bar code affixed to the outside of the test tube can be accurately read.

In a bar code reading apparatus having two readers, the readers are placed at a position symmetric with respect to a lifted test tube. A test tube lifted to the bar code reading position is rotated reversibly together with the clamp unit through a range of 180 degrees by the test tube rotating mechanism. By providing two readers, a bar code can be certainly read by one of the readers by rotating the test tube by 180 degrees. Namely, a series of operations for reading a bar code of a test tube can be executed in a shorter time than an apparatus having only one reader.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A bar code reading apparatus for reading a bar code indicated on the outer periphery of a test tube held by a test tube holder and conveyed on a conveying path, the bar code reading apparatus comprising:
a reader which is provided on both sides of a bar code reading position set above on the way of the conveying path, and reads the bar code; and
a test tube handling mechanism which is placed above the bar code reading position, descends to grab a test tube held by the test tube holder stopped at a test tube lifting position set on the conveying path right below the bar code reading position, ascends to pull out the test tube from the test tube holder, and faces the bar code to the reader by rotating the lifted test tube around a vertical axis at the bar code reading position.

2. The bar code reading apparatus according to claim 1, wherein the test tube handling mechanism has:
a clamp unit which includes a pair of clamps to nip the upper part of the test tube, and an open/close cylinder to drive the clamps;
a lifting unit which holds the clamp unit rotatably;
a rotation-driving unit which is provided in the lifting unit, and rotates the clamp unit; and
a lifting cylinder which has a stroke to move the lifting unit from a lower limit position where the clamps grab the test tube, to an upper limit position where the test tube is pulled out from the test tube holder to the height sufficient to rotate the test tube.

3. The bar code reading apparatus according to claim 2, wherein two readers are provided and placed at the height capable of reading the bar code of the test tube held at the bar code reading position, and at the position symmetric with respect to the test tube; and the rotation-driving unit rotates the clamp unit reversibly in a range of 180 degrees.
